(19) United States
(12) Patent Application Publication
(10) Pub. No.: US 2007/0288836 A1
(43) Pub. Date: Dec. 13, 2007

(54) SYSTEM, APPARATUS AND METHOD FOR CREATING AND ACCESSING PODCASTS

(75) Inventor: Ali Partovi, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Evolution Artists, Inc., San Francisco, CA (US)

(21) Appl. No.: 11/423,125

(22) Filed: Jun. 8, 2006

(51) Int. Cl. G06F 17/00

(52) U.S. Cl. 715/500.1

(57) ABSTRACT

A system, apparatus, and method for creating and playing back audio or multimedia content. In the case of audio content, the content may be created using a telephony instrument such as a telephone or mobile cell phone. In the case of a mobile wireless device having the ability to capture images or video, the content may be photos or video that is captured and uploaded to the inventive system. In one example, the content may be an episode of a podcast. The content is accessed and played back using a web page embeddable content player, with the player accessing an index file that contains information regarding the location and playback control of the content.

### BACKGROUND OF THE INVENTION

The present invention is directed to systems, apparatus and methods for creating audio or multimedia content that may be accessed via a webpage, and more specifically, to a system that may be used to create an audio file such as a podcast episode using a telephony instrument, with the audio file and associated files forming a podcast that may be accessed for playback through a webpage.

Podcasting refers to a method of distributing multimedia files, such as audio programs or music videos, over the Internet for playback on mobile devices and personal computers. Such playback devices include MP3 players and laptop computers. A podcast is typically a digital recording of a radio broadcast or similar program, made available on the Internet for downloading to a personal audio player. A podcast may also include content created by an individual and distributed over a network for access and downloading by others. A podcast typically includes one or more “episodes”, each of which represent an audio or multimedia file that is intended to be played back in a specific sequence.

Podcasts are typically distributed using either the RSS or Atom syndication formats (termed a “feed”) and are typically made available under a subscription model. A subscriber will access one or more syndication feeds on a regular basis, thereby receiving content that is automatically downloaded and made available on the device of choice. The content may be an audio or video feed from a news show, lecture, or other form of entertainment. It may be enjoyed by the consumer where and when they desire, in contrast to many other forms of content distribution.

To create a podcast, a content provider begins by making a file (for example, an MP3 audio file) available on the Internet. This is usually done by posting the file on a publicly-available web server; however, other methods may be used and it is not necessary that the file be publicly accessible. To ensure availability, the uploaded file should be accessible through a previously known or newly provided URI (a general-purpose Internet address).

The content provider indicates the availability of the uploaded file by referencing it in a file known as a “feed”. In a standard implementation, a feed is a machine-readable list of the URIs at which the podcast or in some cases, episodes of the podcast may be accessed. This list is published in a standardized format (such as RSS or Atom format), which may also provide other information, such as publication dates, titles, and accompanying text descriptions of the podcast.

The content provider posts the feed to a known (or newly provided) location on a web server. The location at which the feed is posted is known as the feed URI (or feed URL). The content provider may make the feed URI known to the intended audience by advertisement, placement of a link on a webpage found through a search process or placement of a link on a relevant portal, etc.

A user wishing to access the feed URI uses a software program, termed an aggregator, which functions to retrieve and process data from the feed URI. The aggregator may be an always-on program that runs in the background. It typically manages a set of feed URIs specified by the user and downloads each at a specified interval. An aggregator program may automatically make a newly downloaded episode of a podcast available to a user's portable media player (such as a MP3 player). Downloaded episodes can be played, replayed, or archived as with other computer files.

Podcasting has become an important avenue for personal expression, with implications for social networking, political discourse and the relatively inexpensive distribution of content created by individuals. However, standard methods of creating and accessing podcasts have some disadvantages that may limit the growth of this form of expression. For example, to record a podcast episode (i.e., to create the content that will be made publicly available), a user may need to utilize a microphone to record the audio content in a file on a local computer, and then convert that content into the proper format for use as a podcast. This process could be confusing for some users, and is prone to error in the conversion and process of uploading the converted file to the Internet or other network.

In addition, access or playback of an uploaded podcast requires installation and proper configuration of aggregator software on a local computer, and later transfer to the desired playback device. These steps can be confusing for end users and introduce errors that discourage accessing of the content. Further, the present methods of access and playback are either limited to access and playback of a single file or podcast episode, or require the installation of an application by the end user (which, as noted may introduce errors and result in discouraging end user consumption of the content).

What is desired is a system, apparatus and method for creating content for a podcast and permitting access to that content, where such system, apparatus, and method overcomes the noted disadvantages.

### BRIEF SUMMARY OF THE INVENTION

The present invention is directed to a system, apparatus, and method for creating and playing back audio or multimedia content. In the case of audio content, the content may be created using a telephony instrument such as a telephone or mobile cell phone. In the case of a mobile wireless device having the ability to capture images or video, the content may be photos or video that is captured and uploaded to the inventive system. In one example, the content may be an episode of a podcast. The content is accessed and played back using a web page embeddable content player, with the player accessing an index file that contains information regarding the location and control of the playback of the content.

In one embodiment, the present invention includes a telephony server coupled to a telephony instrument and configured to execute an audio input application, where the application is configured to receive audio input data from a user via the telephony instrument and to present the user with a user interface that permits the user to control the input and storage of the audio input data; a user database coupled to the telephony server, where the user database includes a user account; an audio storage medium coupled to the telephony server, where the audio storage medium includes a Content Index associated with the user account, and the Content Index includes a reference to an audio file, where the audio file contains the audio input data from the user; and a server coupled to the audio storage medium and to a user application, where the server is configured to provide content to the user application, and the content includes a reference capable of providing access to the Content Index and to a playback application, where the playback application is configured to process the Content Index and playback the audio file referenced by the Content Index.

In another embodiment, the present invention is directed to a method of providing access to multimedia content that includes receiving the multimedia content from a content publisher, storing the multimedia content in a content store, creating a content index, where the content index references the multimedia content, and in response to a user activating a web page reference, providing a reference to the content index and to a content player to the user, wherein the content player is configured to process the content index and playback the multimedia content in accordance with information contained in the content index.

In yet another embodiment, the present invention is directed to a method of providing access to audio content that includes providing a telephony server configured to permit input of the audio content using a telephony instrument, receiving and storing the input audio content, associating the received input audio content with a user account, associating the user account with a Content Index, where the Content Index includes a reference to a location of the stored input audio content, and providing a reference to a content playback application and to the Content Index on a web page, wherein upon activation of the reference the content playback application is downloaded, the Content Index is processed, and the input audio content is played in accordance with control instructions contained in the Content Index.

Other objects and advantages of the present invention will be apparent to one of ordinary skill in the art upon review of the detailed description of the present invention.

### BRIEF DESCRIPTION OF THE DRAWINGS

FIG. 1 is a functional block diagram of a system for creating and accessing a content file such as a podcast episode, in accordance with the present invention.

FIG. 2 is a flow chart depicting an example process for the creation of a content file in accordance with the present invention.

FIG. 3 is a flow chart depicting an example process for accessing a content file in accordance with the present invention.

### DETAILED DESCRIPTION OF THE INVENTION

The present invention is directed to a system, apparatus, and method that may be used to create and provide access to an audio file such as a podcast episode. The invention permits a user to create and upload an audio file to a server using a telephony instrument such as a standard telephone or wireless mobile phone. The uploaded file may then be accessed through a web page, with a web server hosting the web page. The web server provides access to a file that indexes the uploaded file and also provides access to an embedded software program that can be used to play the file or sequence of files specified by the index file.

Although the present invention will be described with reference to example embodiments, it is noted that practice of the invention is not limited to those embodiments. For example, the uploaded content may be audio, video, animation, images, or other forms of multimedia. The content may be provided by an audio input device, such as a telephony instrument, or by a computing device such as a personal computer, PDA, laptop, etc. In addition, although certain elements of the inventive system may be depicted as residing in a server or servers, or connected by means of a network or networks, such elements may be separate from one another, or combined, and connected as desired to implement the functions and processes of the invention.

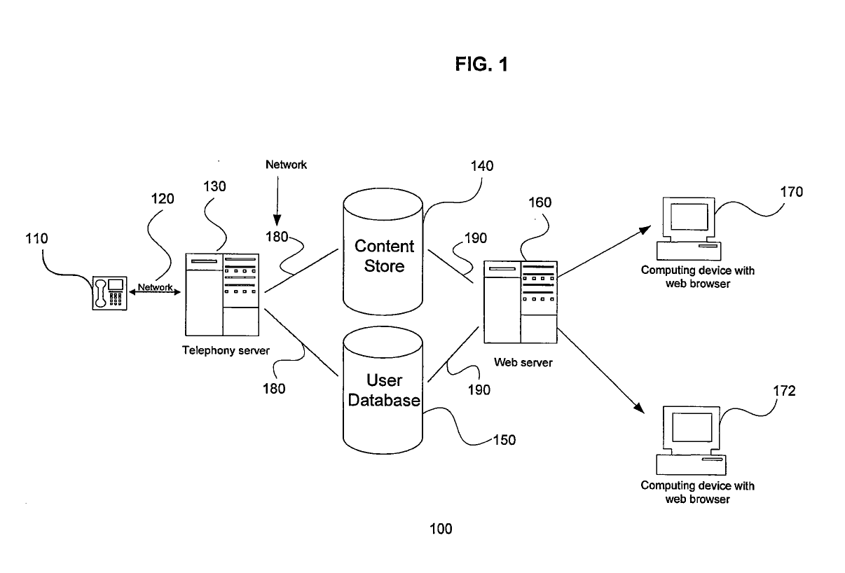

FIG. 1 is a functional block diagram of a system 100 for creating and accessing a content file such as a podcast episode, in accordance with the present invention. System 100 includes a telephony instrument 110, which may be a standard telephone or wireless mobile device such as a wireless handset, cell phone, or PDA having telephony capabilities. Telephony instrument 110 is capable of receiving audio input from a user and transferring that input to a network 120 (e.g., the PSTN (public switched telephone network)). Network 120 may be a broadband network and may not be solely dedicated to transfer of voice data; for example, network 120 may be a broadband voice and data network (e.g., a cable television or VoIP network). Network 120 connects telephony instrument 110 to a telephony server 130. Telephony server 130 is configured to receive the audio input and execute a voice-application interface. The interface is configured to allow a user (i.e., a caller) to (a) provide authentication data to identify themselves (e.g., using a numeric user-id and/or PIN); (b) record an audio message or other form of audio content; and (c) review the audio content and choose to re-record or “save/publish” the content. In this context, to “publish” the input content means to make the content available to others over a network in accordance with the present invention.

Telephony server 130 is configured to communicate with Content Store 140 and user database 150 over network 180. Network 180 may be a public network such as the Internet, a private network, or a combination of public and private networks. Network 180 may similarly be a wired network, wireless network, or a combination of the two. User database 150 includes a database of User Accounts, with each account corresponding to a creator of content, or in the case of multiple User Accounts for the same creator, to different sets of created content. In one implementation, for each user, database 150 stores an alphanumeric Userid (e.g., email name for a user), password, Numeric UserID (e.g., phone number), and PIN (personal identification number) or other form of security code. The Numeric UserID can be used to identify a call as being associated with a particular podcast or podcast episode. Note that the Numeric User ID may correspond to the number being called or the number from which the call originates (i.e., the content creator's own number). In the case of the Numeric User ID corresponding to the number being called, caller-ID or the entry of user authentication data may be used to identify a specific user for the case of a number that is shared by multiple users (e.g., a community of content creators who may be participating in a forum or other group discussion, or multiple users accessing the system via a single or limited number of access numbers). In the case of a dedicated number being called in order to create the content, the number called or the caller-ID of the user placing the call may be automatically associated with a single user account. Further, the optional PIN or other security code may be used to control access to or provide an additional layer of security for the system and system functions by authenticating the caller. The UserID and password may optionally be used to manage a user's account from a web browser or other application. Each User Account is associated with one or more Content Indexes, which are described in greater detail with reference to the Content Store 140, below.

Content Store 140 is a data storage medium configured to store one or more audio or other content files associated with a user account. For each user account there is at least one associated Content Index (e.g., a file, or rows in a database) that references one or more data files (e.g., audio content) in Content Store 140. Note that the Content Index may be co-located with Content Store 140 (i.e., stored on the same server), or may be stored separately. The data files stored in Content Store 140 may have been uploaded from a web page to Content Store 140 or be provided from a telephony instrument 110. Note that the ability to provide an audio file via a telephony instrument and then to permit play back of a sequence of such files using a web-embeddable player is one feature of the present invention.

Web server 160 is configured to communicate with Content Store 140 and user database 150 over network 190. Network 190 may be of the same or different type than network 180, but as with network 180, may be a combination of public, private, wired or wireless networks. Web server 160 is one or more devices that interface to network 190 (e.g., the Internet) using the appropriate protocol(s) (e.g., TCP/IP, HTTP) and provide web pages (HTML) or data (XML) to other devices. Web server 160 provides a web browser accessible (e.g., HTML) user-interface that enables a podcast-publisher (e.g., content creator) to create an account in user database 150. Web server 160 thus provides a generically-accessible data-interface to permit creation of files for and access to, among other things, user database 150 and to the Content Index and stored audio files in Content Store 140 for a specified user account using a computing device equipped with a web browser 170. Similarly, web server 160 or a different server may provide a user-interface that is used by a potential consumer (via a computing device 172) of the podcast or podcast episode to access a web page containing an embeddable content player, with that player used to access the content of the podcast or podcast episode by utilizing the information contained in the relevant Content Index.

As mentioned, in an example implementation, access to the audio or other content stored in Content Store 140 is facilitated by an Content Index associated with a user account. The Content Index is an index or other form of list for a set of audio content that together form a podcast. Thus, the Content Index represents a file or database entries that can be used to access a set of content that is intended to be played back to a consumer as a unit or podcast. For example, the file can provide links to and/or additional information regarding the audio files or other content that are intended to be part of the podcast. This content can take the form of MP3 files, other forms of multimedia content, links to other sources of content (such as web-sites). In addition to the content, the Content Index may include data describing control of the playback of the content, e.g., sequencing, formatting, interleaving with associated content, etc.

As an example, the Content Index may be implemented as an XML file in the RSS format, containing “tags” that identify descriptive information and links to a set of MP3 recordings that together form a podcast. Note that this is a standard format for a “podcast”, but that the present invention is not limited to this format. As noted, the links may be to other forms of content, e.g., multimedia, and the Content Index may include sequencing or other relevant information for controlling the playback of the content.

As an example, below is a possible Content Index file that provides a link to content and descriptive information about that content that may be displayed by a content player:

<rss version=“2.0”>
<channel>
<title>User podcast channel</title>
<description> The User podcast channel featuring commentary, music, backstage chatter, and
voice messages from the User. </description>
<link>http://www.host.com/user/USER/podcast/main</link>
<language>en-us</language>
<lastBuildDate>Mon, 27 Feb 2006 10:42:10 +0000</lastBuildDate>
<ttl>1440</ttl>
<copyright>2005 User</copyright>
<summary>The User podcast channel featuring commentary, music, backstage chatter, and
voice messages from the User.<summary>
<generator> htdb.org RSSifier </generator>
<item>
<title>Episode 2 - Crash</title>
<description>Episode 2 - Crash</description>
<link>http://www.host.com/user/User/podcast/main</link>
<guid> .C5iOZy6E </guid>
<enclosure url=“http://www.host.com/mp3/.C5iOZy6E/01_Episode_2__Plane_Crash.mp3”
length=“7579355”type=“audio/mpeg”/>
<pubDate>Mon, 27 Feb 2006 10:42:10 +0000</pubDate>
</item>
<item>
<title>Episode 1 - I Want My Car Back</title>
<description>It's been a bad day and I want my car back.</description>
<link>http://www.host.com/user/User/podcast/main</link>
<guid> .C5mJbC2C </guid>
<enclosure
url=“http://www.host.com/mp3/.C5mJbC2C/01_Episode_1__I_Want_My_Car_Back.mp3”
length=“3580933” type=“audio/mpeg”/>
<pubDate>Sun, 05 Feb 2006 21:03:21 +0000</pubDate>
</item>
</channel>
</rss>

In addition to the Content Index, web server 160 provides access to software code or other type of executable instruction for a client-side content player (i.e., for a consumer to use on computing device 172) that may be embedded in a web page provided to a consumer. The server may provide the actual code or a link to the content player. The content player is used by a consumer (e.g., a member of the audience for a podcast) to playback the podcast in the order that is specified by the control data in the Content Index (e.g., as defined by a tag or by the sequence of content described in the Content Index). Thus, in an example implementation, a consumer visits a web page that provides access to the desired podcast. The consumer will activate a link for the podcast; this will download and activate the client-side content player. The player will then fetch or be provided the relevant Content Index for the specified podcast. As noted, the Content Index references one or more audio or other files that are intended to be played in an appropriate sequence. In conjunction with the previously described method of creating and uploading audio content, this permits a phone-recorded podcast or set of podcast episodes to be accessed and played through a web page in a desired sequence.

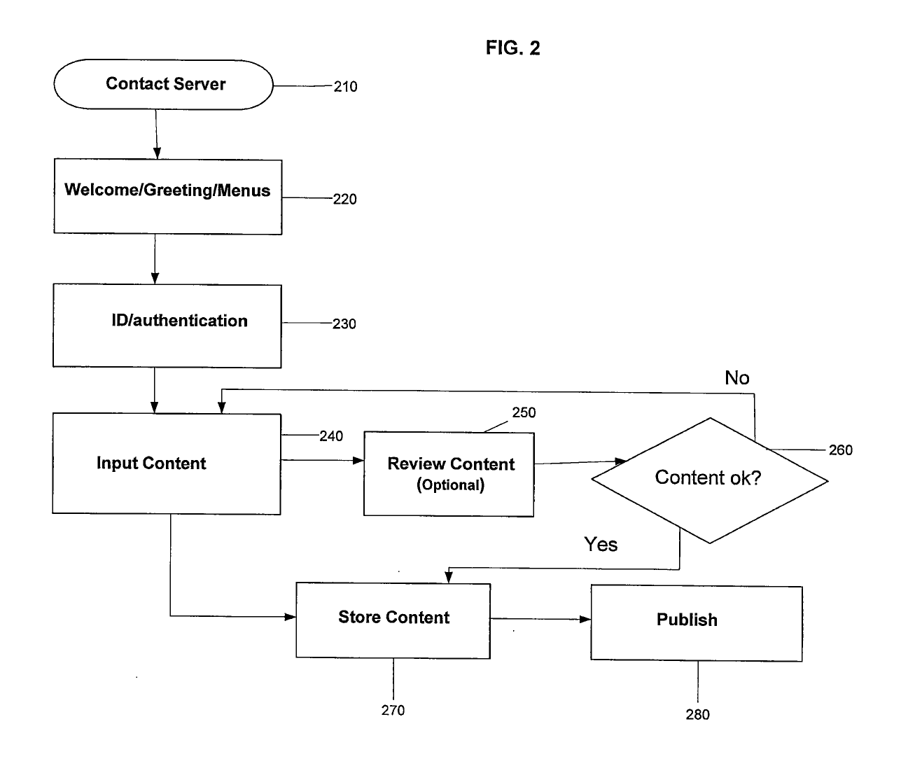

FIG. 2 is a flowchart depicting an example process for the creation of a content file in accordance with the present invention. As discussed, the “content” file may be an episode of a podcast, and may include audio or other multimedia data provided via a telephony instrument or other suitable data input mechanism. The podcast or podcast episodes may therefore include audio content, video content, images, animation, a link to other content that is played upon activation of a link, etc. For example, in the case of the telephony instrument being a mobile wireless phone, the podcast or podcast episodes may include photos or video captured by the phone and uploaded to the content store or other elements of the inventive system. The podcast or podcast episode may represent a travel log, commentary, political discussion, musical performance, advertisement, etc.

Referring to FIG. 2, in step 210, a user (content creator) of the inventive system accesses a previously created (or creates a new) podcast-publisher account. This is performed by contacting the telephony server (element 130 of FIG. 1) using the telephony instrument 110. Note that setup of the account can be implemented in multiple ways; e.g., via a web page, via a phone, or as a result of a customer support agent who performs the process for the prospective publisher. As a result of the account creation process, User database 150 stores the Numeric UserId and PIN for the prospective podcast publisher. An alphanumeric Userid/password may be created to provide additional authentication and access control (for example, if the account is created using a web page). Upon connection to the telephony server (by dialing and being connected to a specified phone number, for example), the telephony server may playback a greeting or menu of possible actions (step 220 in FIG. 2). The user may be asked to enter authentication or other access control data in order to access the user account (step 230).

As noted, to create a podcast episode or other form of distributable multimedia file (e.g., audio), the prospective podcast-publisher may place a phone call to set up a new account or access a previously set up account, and to record audio content for the episode. The phone call may be placed to a shared number (and thus may be shared by multiple podcast-publishers as part of a common forum, or be used by multiple users to access the system), or to a personal number that is unique to a single podcast publisher. If the called number is shared by multiple users, then Telephony Server 130 may be configured to recognize the podcast-publisher's Numeric UserID in order to determine the proper account to associate with the call. The determination of the Numeric UserID may occur as a result of an application running on telephony server 130 recognizing the Numeric UserID because it is the caller-ID (i.e., the caller's phone number), or because the authentication data is provided by the caller as a form of identification. If the called number is a personal number associated with a single user, then Telephony Server 130 may use the DNIS protocol to identify what phone number is being called or the number placing the call, in order to identify the user account associated with the caller (user). For authentication purposes, the caller may be requested to enter an optional PIN to verify that they are the owner of the associated podcast-publisher user account (as in step 230 of FIG. 2). The specific method used for authenticating the user is not limited to those mentioned; what is important is that upon placing the phone call, the caller is associated (via information contained in the User Database) with a User Account. The User Account is associated with or contains a previously described Content Index. If necessary, the Content Index may be created and associated with the User Account at the time of the call.

Upon being authenticated, the user (caller) may be prompted to record or otherwise provide (e.g., upload) the desired audio or other content over the telephony connection (step 240). In accordance with the voice application resident on telephony server 130, provision of the audio or other content may be terminated by pressing a key, a long pause, or other control function. The audio or other content may be reviewed (an optional step shown at step 250), and optionally erased/re-recorded/re-uploaded. When the user accepts the recorded/uploaded content (e.g., by replying “Yes” to the “Content ok?” query at step 260 or entry of a designated key press or other input), the content is stored in Content Store 140 (at step 270) and the relevant information for playback access and control is added in the proper format to the Content Index of recordings/content uploads for the caller's podcast (step 280). Note that the publishing action of adding the information regarding the recorded content to the Content Index may be performed automatically or upon receipt of the appropriate user input.

Note that as mentioned, Content Store 140 may include audio and/or multimedia content (e.g., photos, videos, etc.) that was uploaded or otherwise provided by another mechanism, for example via uploading from a computer or phone that includes photo and/or video capture capabilities. In addition, note that content may not be automatically published to the Content Index but instead may be temporarily saved and then subjected to rearrangement, deletion, modification, or other operations using a web page interface before being “published” to the Content Index. In this way, the telephony instrument can be used to provide audio content, while a computing device can be used to manipulate or otherwise configure the audio or other content. Note that a podcast-publisher may have more than one Content Index file associated with that publisher, and may be prompted to select which Content Index file the received audio content should be published to.

In accordance with present invention, the Content Index and the audio (or content) recordings for a particular podcast-publisher are accessible via a network connection. In an exemplary implementation, the network utilizes the TCP/IP HTTP protocols, Internet access to the User Database and Content Store, the Content Index is in the format of an XML/RSS file, and the audio content are in the form of MP3 files. However, note that other protocol/formats are possible, and the present invention is not limited to those specified.

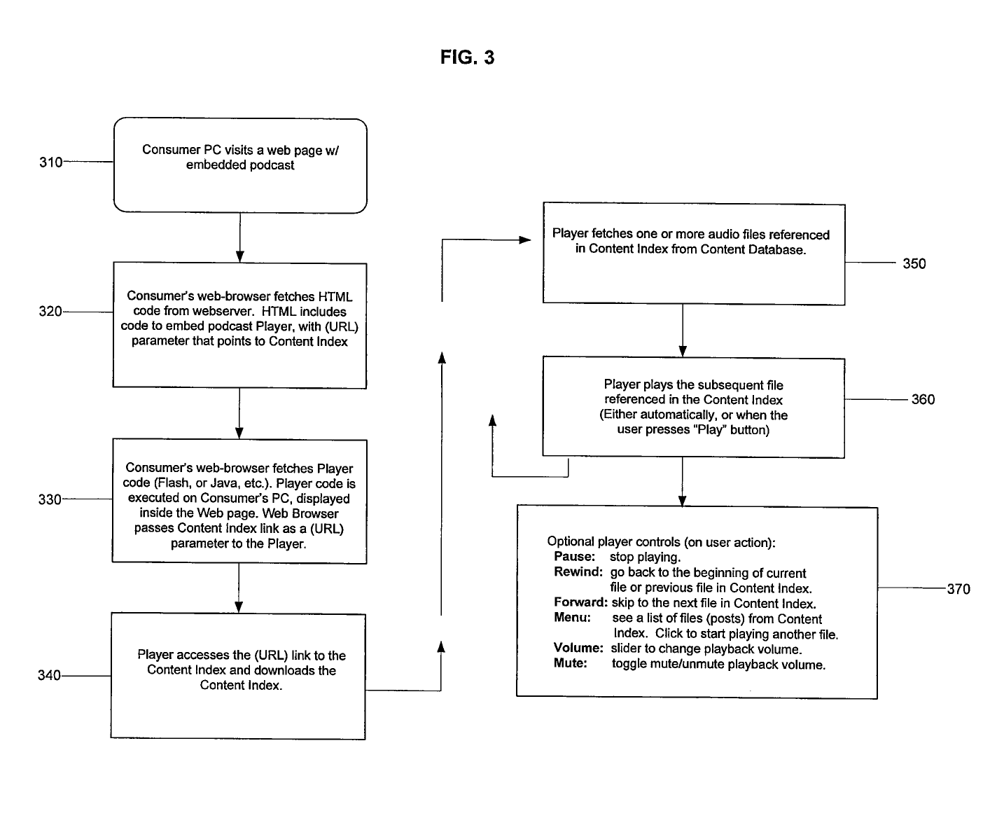

FIG. 3 is a flowchart depicting an example process for accessing a content file in accordance with the present invention. At step 310, a prospective consumer of the content (e.g., podcast or podcast episodes) navigates to a web page that contains a link to the desired content. Upon selection of the link, the consumer's web browser fetches markup language content (e.g., HTML “code”) that includes instructions to enable “embedding” of the content player, along with a parameter (e.g., a URL) that points to the relevant Content Index (step 320). Note that the “link” could also be a reference to a set of executable instructions that provide the functionality of a media player, such as an application written tin JavaScript™ or a similar software tool.

In the case of providing a link to the location of the content player application, the consumer's web browser fetches the software code or other instructions for the content player (step 330) from the location indicated by the link. The link may be to a server operated by a provider of podcast infrastructure, podcast content, or other source. The software code or instructions may be in the form of a Flash™, ActiveX™, Java™ application, or JavaScript™, for example. The software code, instructions, or other form of application are executed on the consumer's computer or other data processing device (element 172 of FIG. 1, for example), and may be displayed within the web page that contains the link to the player. The consumer's browser also passes the URL or other reference to the relevant Content Index as a parameter for use or execution by the content player. In this way the present invention provides a method of accessing a content player and data describing the location and sequencing (or other control data) for the contents to be played back.

The content player then accesses the link to the Content Index (step 340). The content player downloads the Content Index, thereby obtaining links to the desired content and possibly additional control data for playback of the content. The content player may display information from the Content Index, for example, content title(s), descriptions, etc. The content player then fetches one or more audio or multimedia files referenced in the Content Index (step 350). These files are obtained from the Content Store (element 140 in FIG. 1), although they may also be obtained from another location that is referenced by the Content Index. As noted, in an example implementation, the Content Index may be an XML file in RSS format, containing links (HTTP conforming URLs) to MP3 audio files.

The content player plays the fetched data file, either automatically or in response to a “play” command (step 360). Upon conclusion of the playback, the player may automatically fetch the next data file referenced in the Content Index (i.e., the next episode of the podcast). The player may also be configured to pre-fetch and store the next data file referenced instead of waiting until completion of the currently playing file. Note that the content player may include additional controls (as depicted in step 370), such as “Pause”, “Rewind”, “Forward”, “Menu”, as well as volume controls. These controls may be used to control playback of the currently playing file or to access other files referenced in the Content Index. Note that the Content Index may reference audio files, multimedia files, or other content. Thus, a podcast might include recorded audio, video, photographs, animations, etc. that can be referenced by data in the Content Index.

As described, the present invention utilizes a client-side multimedia-player that may be embedded inside a web page and accessed from that page. The playback application is configured to utilize the Content Index to fetch the associated audio (or other) content and permit control of the playback of the content. The client-side player may be implemented in Flash™, ActiveX™, Java™, JavaScript™, or another suitable platform/format. It may be embedded or otherwise inserted inside a web page (e.g., an HTML page) using the <EMBED>, <OBJECT>, or <SCRIPT> tags, for example. When a consumer visits such a web page, their web browser interprets the EMBED, OBJECT, or SCRIPT tag, and downloads and runs the code for the content player. The content player in turn loads the Content Index which references the desired content, which is then played in the indicated sequence. As noted, the content player may include controls for operations such as play/pause/forward/rewind, and/or volume control. It may also provide a visual view of the Content Index to enable the consumer to navigate directly to a desired portion of the content.

For example, a consumer may be permitted to access a podcast by embedding the following HTML markup “code” into a web page (note that the embedded code has two parameters: (1) a URL referencing the content player, in this case a Flash™ application (hostcastplayer); and (2) a URL referencing the relevant Content Index (main.xml)):

<embed
src=‘http://www.hostcast.com/go/hostcastplayer?xmlurl=http://www.hostcast.com/u/User/mai
n.xml’

type=‘application/x-shockwave-flash’ >

</embed>

Note that the content may be provided to a consumer as part of a no-charge service, on a per episode or per podcast basis, a subscription basis, or other form of payment. In such a case, the content or Content Index may be stored on a secure network and/or require some form of authentication for access.

In accordance with the present invention there have been described a system, apparatus, and methods for creating audio or other forms of content for a podcast, and accessing that content via a web page embeddable content player and associated content index. The web page embeddable player is accessed by a consumer's web browser, and the player accesses the relevant content index to obtain the content and control its playback. The audio or other content may be provided by a content creator using a telephony instrument and/or computing device. In one implementation, a content publisher (podcast creator) may create and upload content using a telephone, and provide access to that content via the publisher's web page, where that web page includes a reference that permits access to a playback application. Further, the web page includes a reference to a content index that is provided to the playback application to enable the application to access and properly playback the content.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

1. A system for creating and accessing an audio file, comprising:
a telephony server coupled to a telephony instrument and configured to execute an audio input application, the application configured to receive audio input data from a user via the telephony instrument and to present the user with a user interface, the user interface permitting the user to control the input and storage of the audio input data;
a user database coupled to the telephony server, the user database including a user account;
an audio storage medium coupled to the telephony server, the audio storage medium including a Content Index associated with the user account, the Content Index including a reference to an audio file, the audio file containing the audio input data from the user; and
a server coupled to the audio storage medium and to a user application, the server configured to provide content to the user application, the content including a reference capable of providing access to the Content Index and to a playback application, the playback application configured to process the Content Index and in response to playback the audio file referenced by the Content Index.

2. The system of claim 1, wherein the telephony instrument is a telephone handset.

3. The system of claim 1, wherein the telephony instrument is a wireless phone.

4. The system of claim 1, wherein the content index includes a reference to a plurality of audio files, the reference indicating a location for each of the plurality of audio files.

5. The system of claim 4, wherein the content index includes information regarding control of the playback of the plurality of audio files.

6. The system of claim 4, wherein the playback application processes the Content Index to determine the locations of the audio files.

7. The system of claim 4, wherein the playback application processes the Content Index to determine an order in which to playback the audio files.

8. The system of claim 1, wherein the server is a web server, the user application is a browser, and the content provided to the user application is a web page.

9. The system of claim 8, wherein access to the Content Index and the playback application is provided via a markup language code on the web page.

10. A method of providing access to multimedia content, comprising:
receiving the multimedia content from a content publisher;
storing the multimedia content in a content store;
creating a content index, the content index referencing the multimedia content; and
in response to a user activating a web page reference, providing a reference to the content index and to a content player to the user, wherein the content player is configured to process the content index and playback the multimedia content in accordance with information contained in the content index.

11. The method of claim 10, wherein the multimedia content is received from the content publisher via a telephony instrument.

12. The method of claim 10, wherein the multimedia content is received from the content publisher via a computing device.

13. The method of claim 10, wherein the multimedia content is audio content, photographic image data, or video content.

14. The method of claim 10, wherein the content index includes a reference to a storage location of the multimedia content.

15. The method of claim 10, wherein the content index includes a reference to a storage location of a plurality of multimedia content, and further, wherein the content index includes data for control of the playback of the multimedia content.

16. The method of claim 10, wherein providing a reference to a content player to the user further comprises providing a reference to a location of the content player.

17. The method of claim 16, wherein the reference is a markup language code on a web page, which when activated by a user, initiates a download of the content player and processing of the content index.

18. A method of providing access to audio content, comprising;
providing a telephony server, the telephony server configured to permit input of the audio content using a telephony instrument;
receiving and storing the input audio content;
associating the received input audio content with a user account;
associating the user account with a Content Index, the Content Index including a reference to a location of the stored input audio content;
providing a reference to a content playback application and to the Content Index on a web page, wherein upon activation of the reference
the content playback application is downloaded, the Content Index is processed, and the input audio content is played in accordance with control instructions contained in the Content Index.

19. The method of claim 18, wherein the telephony instrument is a telephone handset.

20. The method of claim 18, wherein the audio content is a plurality of audio files, the Content Index includes a reference to a location for each of the plurality of audio files, and the control instructions include instructions regarding an order in which to playback the plurality of audio files.

21. A method of providing access to content, comprising;
providing a server, the server configured to permit input of the content using an input device;
receiving and storing the input content at the server;
associating the received input content with a user account;
associating the user account with a Content Index, the Content Index including a reference to a location of the stored input content;
providing a reference to a content playback application and to the Content Index on a web page, wherein upon activation of the reference
the content playback application is downloaded, the Content Index is processed, and the input content is played in accordance with control instructions contained in the Content Index.

22. The method of claim 21, wherein the content is one or more of multimedia content, audio content, video content or an image.

23. The method of claim 21, wherein the server is a telephony server.

24. The method of claim 21, wherein the input device is a telephony instrument.

25. The method of claim 24, wherein the telephony instrument is a wireless phone.

26. The method of claim 24, wherein the telephony instrument is a personal data assistant that includes a telephony function.

27. The method of claim 21, wherein the instrument is a computing device.

28. The method of claim 27, wherein the computing device is one of a personal data assistant, a laptop computer, or a desktop computer.

29. The method of claim 11, wherein the telephony instrument is a wireless phone.

30. The method of claim 12, wherein the computing device is a personal data assistant, a laptop computer, or a desktop computer.

31. The method of claim 1, wherein the audio file is associated with video or image data, and further wherein the video or image data is input using the telephony instrument.

32. The method of claim 31, wherein the telephony instrument is a wireless phone.

33. The method of claim 31, wherein the telephony instrument is a personal data assistant, a laptop computer, or a desktop computer equipped with a telephony function.

34. The method of claim 18, wherein the audio content is associated with video or image data, and further wherein the video or image data is input using the telephony instrument.

35. The method of claim 18, wherein the telephony instrument is a wireless phone.

36. The method of claim 18, wherein the telephony instrument is a personal data assistant, a laptop computer, or a desktop computer equipped with a telephony function.

37. The method of claim 34, wherein the telephony instrument is a wireless phone.

38. The method of claim 34, wherein the telephony instrument is a personal data assistant, a laptop computer, or a desktop computer equipped with a telephony function.
